(19) United States
(12) Patent Application Publication
(10) Pub. No.: US 2005/0189784 A1
(43) Pub. Date: Sep. 1, 2005

(54) Sunshade for a motor vehicle, and a vehicle door equipped with such a sunshade

(75) Inventors: Pierre Guerreiro, Sannois (FR); Godefroy Beau, Meru (FR)

Correspondence Address: YOUNG & THOMPSON, 745 SOUTH 23RD STREET, 2ND FLOOR, ARLINGTON, VA, 22202, US

(73) Assignee: FAURECIA INTERIEUR INDUSTRIE, NANTERRE (FR)

(21) Appl. No.: 11/064,816

(22) Filed: Feb. 25, 2005

(30) Foreign Application Priority Data
Feb. 27, 2004 (FR) 04 02059

(51) Int. Cl. B60J 1/20

(52) U.S. Cl. 296/152

(57) ABSTRACT

The sunshade includes a protective screen having a plurality of sections which are connected to one another by hinges, the screen being able to assume a folded position in which the sections are folded onto one another, and a deployed position in which the sections are unfolded; and resilient biasing elements associated with the screen and exerting a biasing force against the deployment of the screen from its folded position. The biasing elements include the hinges connecting the sections. A motor vehicle door including such a sunshade is described.

### BACKGROUND OF THE INVENTION

The present invention relates to a sunshade for a motor vehicle, comprising:
a protective screen having a plurality of sections which are connected to one another by hinges, the screen being able to assume a folded position in which the sections are folded onto one another, and a deployed position in which the sections are unfolded,
resilient biasing means associated with the screen and exerting a biasing force against the deployment of the screen from its folded position.

Such sunshades, which are generally associated with deployment and retraction mechanisms, are known in the prior art. Some of those mechanisms ensure a resilient return of the screen into the folded position by means of resilient cables.

All of those mechanisms bring a substantial number of components into play, especially as it is necessary to guide the cables and as that function is performed by specific components. Those mechanisms are also fragile and subject to some malfunctioning which is caused, for example, by cables jamming or pulleys sticking.

### SUMMARY OF THE INVENTION

The object of the invention is to overcome those disadvantages and to propose a sunshade structure of the type explained above which is more simple and more reliable.

To that end, in a sunshade according to the invention, the biasing means comprise the hinges connecting the sections.

According to other features of the invention, taken alone or in accordance with any technically possible combination:
the screen is composed at least partially of a shape memory material having a folded initial shape;
the initial shape of the screen is a shape folded in the manner of an accordion or in the manner of crenellations;
the screen in its initial shape also has secondary folding, according to which each section is itself folded;
the sunshade comprises means for securing to a portion of the vehicle that are arranged at an edge of the screen, and means for coupling to another portion of the vehicle that are arranged at an opposite edge of the screen and that enable the screen to be maintained in its deployed position against the resilient biasing force; and
the sunshade comprises an operating handle which is fixedly joined to the screen at an edge thereof.

The invention relates also to a motor vehicle door comprising a casing, and a sunshade as described above which is fixedly joined to the casing.

According to other optional features of the door according to the invention:
the casing has an opening at an upper face, and the screen is retracted into the casing in its folded position, while it projects from the casing through the opening in its deployed position;
in the folded position of the screen, the operating handle projects from the casing; and
the door comprises a window frame which is fixedly joined to the casing, and the frame is equipped with complementary coupling means which are provided to co-operate with the coupling means of the sunshade.

### DESCRIPTION OF THE DRAWINGS

Particular embodiments of the invention will now be described in greater detail with reference to the appended drawings in which:

FIG. 1 is a partial diagrammatic perspective view of a door provided with a sunshade according to a first embodiment of the invention;

FIG. 2 is a diagrammatic cross-sectional view, in a vertical plane, of a sunshade screen according to a second embodiment of the invention; and

FIG. 3 is a view similar to FIG. 2 showing the screen of a sunshade according to a third embodiment of the invention.

### DETAILED DESCRIPTION

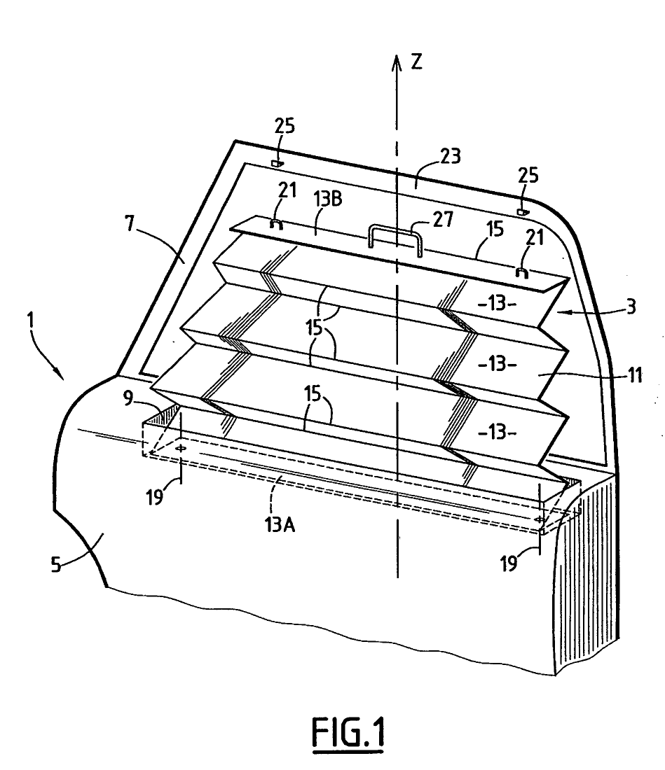

FIG. 1 shows, partially, a motor vehicle door 1 provided with a sunshade 3 according to the invention which may be either retracted or deployed to protect the occupants from the sun's rays passing through the glazed portion of the door.

In that Figure, the door 1 is assumed to be oriented in accordance with its position mounted on the vehicle, and the indicated axis Z is assumed to be vertical. The terms used hereinafter with respect to orientation and position will be understood with reference to that mounted position and that axis.

The door 1 basically comprises a hollow casing 5, inside which equipment is accommodated, a pane of glass (not shown), a window frame 7 fixedly joined to the casing, and the sunshade 3.

On an upper face, the casing 5 is formed with an opening 9 giving access to its interior volume.

The sunshade 3 comprises a protective screen 11 which can be folded and unfolded by a user, between two extreme positions, the one completely folded and the other completely deployed, in accordance with the axis Z.

To that end, the protective screen 11 has a plurality of adjacent sections in the form of strips 13 which are contiguous along parallel lines 15 and which are parallel with one another and substantially horizontal.

In the embodiment shown in FIG. 1, the folding of the screen 11 is referred to as “in the manner of an accordion”, the hinges 15 (or folding lines) being located alternately on one side and the other of a centre plane of the screen.

In this embodiment, the hinges 15 also define strips of the same width.

Thus, in the folded position of the screen, the sections 13 are stacked on one another, and the screen has a width equal to the width of each section. The folded screen has a space requirement which is very small in terms of height and which is substantially equal to the thickness of one section multiplied by the number of sections.

The strip 13A at the lower end is integrated inside the casing 5 and is secured thereto by way of complementary securing means shown diagrammatically by dot-dash lines 19. The complementary securing means of the sunshade and the casing 5 may operate by snap-fitting, screwing, or any other suitable securing method.

The strip 13A at the lower end is secured to the inside of the casing opposite the opening 9.

At the strip 13B at the upper end, the screen 11 is provided with coupling means, for example in the form of bows 21, as shown in FIG. 1. Correspondingly, the frame 7, at its horizontal upper bar 23, is provided with complementary coupling means which are in the form of hooks 25 in the example shown.

In addition, the sunshade 3 comprises an operating handle 27 which is fixedly joined to the screen 11 at the strip 13B at the upper end, the handle 27 enabling a user to unfold or fold the screen 11.

In order to return the screen 11 towards its folded position, the sunshade 3 is provided with resilient biasing means which are integrated in the screen 11 itself. According to the invention, the hinges 15 of the screen 11 exert the resilient biasing effect towards the folded position.

To that end, the screen 11 is composed of a shape memory material whose initial shape corresponds to the folded position in which the sections or strips 13 are folded onto one another.

It is in this manner that the deployment of the screen 11 from its folded position, under the effect of traction exerted by a user on the handle 27 in accordance with the axis Z, is effected against the resilient biasing force of the hinges 15.

It will be appreciated that the complementary coupling means 21, 25 enable the screen 11 to be maintained in its deployed position against the resilient biasing force of the hinges 15. In order to return the screen 11 to its folded position from the deployed position, maintained by the coupling means, a user has only to uncouple the coupling means without any traction force subsequently being required on his/her part.

In order to improve the general aesthetics of the door 1 provided with the sunshade 3, it is provided that the screen 11, in its folded position, is totally retracted into the casing 5. Only the handle 27 then projects outside the casing so that it can be grasped by the user.

It is of course possible to provide other glazed portions of the vehicle with a sunshade as described above, it being possible to accommodate the latter in hollow portions of the bodywork other than door casings, or in items of interior equipment. The sunshade may also be secured to the outside of such casings, bodywork portions or other items of interior equipment. In the same manner, it is possible to provide for the coupling, or more generally the securing, of the screen in the deployed position at any suitable portion of the vehicle, in particular the roof.

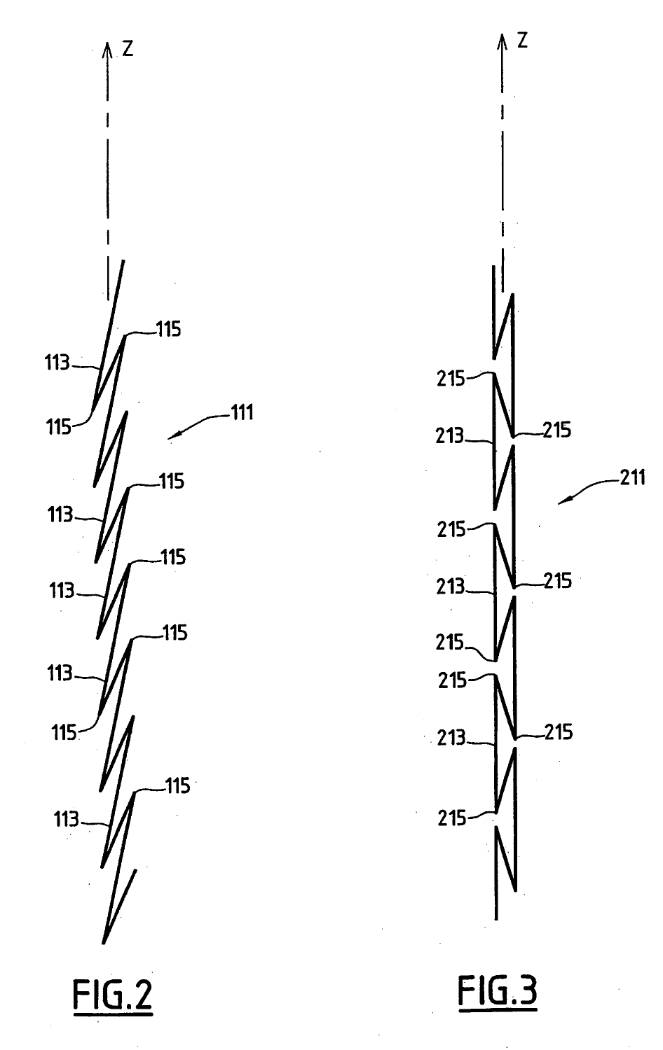

FIG. 2 shows the screen 111 of a sunshade according to a second embodiment of the invention, in the folded configuration.

The screen of that sunshade is similar to the one shown in FIG. 1 except that the type of folding giving the screen 111 its shape is different.

In this embodiment, the screen 111 is also folded in accordance with a shape in which the hinges 115 (or folding lines) are located alternately on one side and the other of a centre plane. The centre plane is symbolized by the axis Z in FIG. 2.

Unlike the embodiment of FIG. 1, the sections or strips 113 are not all of the same width but are alternately single-width and double-width.

FIG. 3 shows the screen 211 of a sunshade according to a third embodiment of the invention, in folded configuration.

In this embodiment, the screen 211 is folded in the manner of crenellations, the strips 213 which define the parallel screen sections being located alternately on one side and the other of a centre plane of the screen while the hinges 215 follow one another in pairs on one side and the other of the centre plane (indicated by the axis Z in FIG. 3).

The embodiments of FIGS. 2 and 3 relate to screens that have, in the folded configuration, a major space requirement in terms of height (greater than the space requirement in terms of height of the screen folded in accordance with the solution shown in FIG. 1). On the other hand, those solutions have the advantage of a very small space requirement in terms of width.

Regardless of the folding adopted, in particular from among the three folding methods described above, it is possible to provide secondary folding which consists in folding each section 13; 113; 213. This secondary folding is advantageously carried out with secondary folding lines parallel with the principal folding lines. It is of course possible to have a secondary folding method which differs from the principal folding method.

Within the scope of the invention, the advantage of secondary folding is to increase the biasing force into the folded position, which is generated by the screen itself. For example, when secondary folding of the accordion type is applied to the principal folding described with reference to FIGS. 2 and 3, this has the advantage of reducing the space requirement in terms of height (in accordance with the Z axis) of the screen in the folded configuration. The forms of folding in FIGS. 2 and 3 combined with such secondary folding therefore have, simultaneously, the advantages of a very small space requirement in terms of width, a small space requirement in terms of height and an increased biasing force to the folded position. This applies in the same manner with the same effects if a secondary folding method as described with reference to FIGS. 2 and 3 is applied to a principal folding form of the accordion type.

Having read the above description, it will be appreciated that the sunshade according to the invention has an extremely simplified structure compared with the sunshades of the prior art owing to the fact that the means for returning the screen into the folded position are integrated in the screen itself. The hinges, that is to say, the folding regions of the screen, themselves participate in the resilient biasing effect and render the addition of external mechanical systems to the screen superfluous in fulfilling the function of returning to the retracted or folded position.

1. A sunshade for a motor vehicle, comprising:
a protective screen having a plurality of sections which are connected to one another by hinges, the screen being able to assume a folded position in which the sections are folded onto one another, and a deployed position in which the sections are unfolded,
resilient biasing means associated with the screen and exerting a biasing force against the deployment of the screen from its folded position, characterized in that the biasing means comprise the hinges connecting the sections.

2. A sunshade according to claim 1, characterized in that the screen is composed at least partially of a shape memory material having a folded initial shape.

3. A sunshade according to claim 2, characterized in that the initial shape of the screen is a shape folded in the manner of an accordion.

4. A sunshade according to claim 2, characterized in that the initial shape of the screen is a shape folded in the manner of crenellations.

5. A sunshade according to claim 2, characterized in that the screen in its initial shape also has secondary folding according to which each section is itself folded.

6. A sunshade according to claim 1, characterized in that it comprises means for securing to a portion of the vehicle that are arranged at an edge region of the screen, and means for coupling to another portion of the vehicle that are arranged at an opposite edge region of the screen and that enable the screen to be maintained in its deployed position against the resilient biasing force.

7. A sunshade according to claim 1, characterized in that it comprises an operating handle which is fixedly joined to the screen at an edge region thereof.

8. A motor vehicle door comprising a hollow casing, characterized in that it also comprises a sunshade according to claim 6, which is fixedly joined to the casing.

9. A vehicle door according to claim 8, characterized in that the casing has an opening at an upper face, and in that the screen is retracted into the casing in its folded position, while it projects from the casing through the opening in its deployed position.

10. A door according to claim 9, in which the sunshade comprises an operating handle which is fixedly joined to the screen at an edge region thereof, characterized in that, in the folded position of the screen, the operating handle projects from the casing.

11. A door according to claim 8, in which the sunshade, characterized in that it comprises a window frame which is fixedly joined to the casing, and the frame is equipped with complementary coupling means which are provided to co-operate with the coupling means of the sunshade.

12. A motor vehicle door comprising a hollow casing, characterized in that it also comprises a sunshade according to claim 1, which is fixedly joined to the casing.
